(19) United States
(12) Patent Application Publication
(10) Pub. No.: US 2006/0194091 A1
(43) Pub. Date: Aug. 31, 2006

(54) Fuel cell system with a recirculating operating material

(76) Inventors: Willi Strohl, Beilstein (DE); Guenther Bantleon, Leonberg (DE); Thanh-Hung Nguyen-Schaefer, Asperg (DE); Klaus Reymann, Gerlingen (DE); Michael Baeuerle, Ditzingen-Heimerdingen (DE); Helmut Schneider, Aichtal (DE); Gunter Winkler, Stuttgart (DE); Thomas Heid, Renchen-Ulm (DE)

Correspondence Address: STRIKER, STRIKER & STENBY, 103 EAST NECK ROAD, HUNGTINGTON, NY, 11743, US

(21) Appl. No.: 11/361,083

(22) Filed: Feb. 23, 2006

(30) Foreign Application Priority Data
Feb. 28, 2005 (DE) 10 2005 009674.3

(51) Int. Cl. H01M 8/04

(52) U.S. Cl. 429/34

(57) ABSTRACT

A fuel cell system has a fuel cell unit including an anode, and a recirculation unit for recirculating hydrogenous operating material flowing out of the fuel cell unit back into the fuel cell unit, wherein the recirculation unit has at least one drive unit for driving a flow of an operating material, and the drive unit is configured as a pneumatic drive unit or hydraulic drive unit for utilizing an energy of a fluid.

### BACKGROUND OF THE INVENTION

The present invention relates to a fuel cell system with a fuel cell unit.

Interest in hydrogen as an energy carrier for the future has increased markedly in recent years. Electrical energy and heat can be produced in an environmentally safe manner in particular using fuel cells operated with hydrogen. The efficiency of fuel cells is not limited by the Carnot process. Given such high efficiencies, fossil resources can be spared and consumption thereof reduced, e.g., by using fuel cells in motor vehicles or heat and power coupling systems.

PEM fuel cells (polymer electrolyte membrane fuel cells), among others, are currently used in motor vehicle applications. PEM fuel cells utilize proton-conducting polymer membranes, which currently require hydrogen in the purest form possible as the fuel. In motor vehicle applications or other standalone systems, hydrogen or the hydrogenous fuel is preferably stored in pressure tanks. Pressure containers of this type are currently designed for accumulator pressures of approx. 200 to 300 bar, with some designed for accumulator pressures up to 700 bar.

In addition to storing hydrogen in pressure tanks, the method of reforming or the like of hydrocarbons, e.g., gasoline or diesel fuel, is already being used “on board” in motor vehicle applications. Pressurized accumulators for hydrogen, etc., are used in particular to improve adaptation to load changes and cold-start behavior when operation of the reforming process and the like is interrupted.

Fuel cells are used not only in motor vehicles to produce drive energy with the aid of suitable electric drive motors, they are also used as APUs (auxiliary power units) in motor vehicle applications.

In fuel cell applications, the fuel and/or hydrogen is often supplied to the anode in a stoichiometric excess of typically up to a factor of 1.3 (lambda≦1.3) to better maximize the output potential of the fuel cells. The unused or excess hydrogen leaves the outlet of the anode and can be returned and/or recirculated, e.g., to the inlet of the anode.

This is generally realized using a compressor with an electric motor drive. The advantage of the electric motor is that it can be adapted very flexibly to load changes simply by being turned on or off. Due to the risk of explosion, special care must be taken in sealing off the compressor from the electric motor. Even a mixture of approximately 4 percent by volume of hydrogen in normal air is ignitable.

A further disadvantage is the fact that the order of magnitude of electrical energy consumption by the compressor is approximately 2 kW with a motor vehicle drive output of 80 kW.

### SUMMARY OF THE INVENTION

The object of the present invention is to provide a fuel cell system that has a fuel cell unit with an anode, a recirculation unit being provided for recirculating hydrogenous operating material back into the fuel cell unit, and the recirculation unit having at least one drive unit for driving the flow of the operating material, the fuel cell system having a higher level of functional security.

Accordingly, a fuel cell system according to the present invention is characterized by the fact that the drive unit is designed as a pneumatic or hydraulic drive unit for utilizing the energy of a fluid.

With the aid of the drive unit according to the present invention, the risk of explosion due to potential leaks in the recirculating unit and/or a compressor or the like is eliminated entirely. Much lower requirements can therefore be placed on the recirculation unit in terms of sealing, and this can result, e.g., in lower manufacturing costs.

A pneumatic or hydraulic drive unit according to the present invention for preventing potential explosions, of hydrogen in particular, due to leaks is a departure from current relevant development work, in the case of which an attempt was made to seal off the recirculation unit and/or the corresponding compressor or the like from the drive unit as well as possible, and to reduce the risk of leakage via design measures, etc., some of which were very complex. Given a rotating drive shaft according to the related art, however, this task is extremely complex and susceptible to disruption.

In addition, according to the present invention, a marked reduction in the “parasitic load” can be attained and the electrical consumption by the recirculation unit can be reduced, e.g., by 2 kW, compared with the related art. As a result, the overall efficiency of the fuel cell system according to the present invention is markedly improved, which, in turn, enables an economically favorable method of operation.

The pneumatic or hydraulic drive unit according to the present invention can utilize, e.g., the energy of the fluid flow. A hydraulic gear motor/machine or the like, for example, can be used for this purpose. A hydraulic gear motor is a relatively economical option, for example, for utilizing the energy in a flowing fluid to realize the present invention.

The drive unit is preferably designed as an expansion machine for utilizing the expansion energy of the expanding fluid. In fuel cell systems according to the related art, fluids pressurized in highly diverse manners are already being used for highly diverse purposes and applications. According to this variation of the present invention, the pressure energy of fluids of this type are used, advantageously, for the drive unit according to the present invention. This can mean, for example, that, according to the present invention, at least a portion of the compression work carried out to compress the fluid can be reclaimed.

In a particular refinement of the present invention, the pneumatic or hydraulic drive unit is designed as a multistaged drive unit, the pressure being transferred from a higher level to a somewhat lower level at each stage, for example, and, at the next level, the pressure being subsequently transferred to an even lower pressure level, etc. With this method, very efficient utilization of the pressure energy can be achieved, and intermediate warming of the fluid—which cools off during expansion—can be realized, e.g., with the aid of one or more heating units.

The heating unit can be preferably designed as a heat exchanger. The heat exchanger can use, e.g., the heat dissipated from the fuel cell unit, the internal combustion engine and/or other heat-generating components, such as the reformer or the like, to warm the fluid.

The recirculation unit preferably includes at least one compressor for compressing the operating material and/or the fluid. This allows, e.g., the difference in pressure between the anode outlet and the anode inlet to be compensated for in an advantageous manner. The compressor according to the present invention is designed, e.g., as a screw, scroll and/or vane compressor, and/or as a turbine or the like. Preferably, common commercial components and/or compressors are used, by way of which an economically particularly favorable embodiment of the present invention is attainable.

In a preferred embodiment of the present invention, a mechanical coupling device is provided to couple the compressor with the pneumatic or hydraulic drive unit. Functional security is increased further as a result of this measure. The coupling device preferably includes at least one shaft. This enables a particularly easily realizable coupling between the compressor and the pneumatic or hydraulic drive. For example, the drive and the compressor are located on the same shaft. This reduces the design complexity according to the present invention.

For example, the drive unit and the compressor are separated from each other in separate housings and/or via a partition or the like. The pneumatic or hydraulic drive unit and the compressor are preferably located in a common housing and/or have a common housing. As a result, e.g., if a leak occurs, the hydrogenous operating material flowing out of the compressor can flow, e.g., into the drive unit, so that the hydrogenous operating material can be advantageously carried away, thereby ensuring that hydrogen will not accumulate within the critical explosion limits. This also increases the safety of the present invention.

In addition, the drive unit, for example, can direct the hydrogenous operating material into the fuel cell unit, so that the hydrogenous operating material that leaked out can be reused.

It is generally advantageous to design the pneumatic or hydraulic drive unit as a compressor. This allows realization of a particularly simple drive unit according to the present invention.

Compressor elements of the compressor are preferably designed as expansion elements of the expansion machine. This allows elements of this type to be used in multiple manners, which markedly reduces the design complexity of the present invention. The compressor elements and/or the expansion elements are preferably designed, in particular, as movable vanes of a common rotor. Design complexity can be simplified further as a result. For example, the rotor rotates inside the common housing and includes compressor and expansion elements which compress and expand the operating material and the fluid.

In a particularly advantageous embodiment of the present invention, the fluid is essentially the fuel for the fuel cell unit. As a result, the energy, in particular the energy of flow and/or the pressure energy of the fuel, becomes available for driving the recirculation of the operating material in a particularly elegant manner. For example, hydrogenous operating material flowing out of the anode always accumulates when fuel flows into the fuel cell unit, thereby enabling the recirculating operating material to be driven in a manner that is relatively easy to control.

A bypass is preferably provided for bypassing the drive unit. The bypass can be used, e.g., to supply the quantity of hydrogen or fuel to the fuel cell unit independently of the propulsion of the recirculating operating material. This means, in particular, that a decoupling of the fuel quantity supplied to the anode from the recirculating fuel quantity can be realized in an advantageous manner. For example, the bypass includes an actuating component, in particular a variable throttle, with which the fuel quantity and/or the operating material quantity can be advantageously adjusted. The bypass can be eliminated, e.g., if a drive which is independent of the fuel quantity supplied to the fuel cell unit is not required.

In an advantageous variation of the present invention, the drive unit is located in the flow between a fuel pressure accumulator and/or regulator and the fuel cell unit and/or fuel metering unit. As a result, the pressurized fuel is usable in an advantageous manner to drive the recirculation circuit.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 Shows a schematic diagram of an embodiment according to the present invention, and

FIG. 2 Shows a schematic illustration of a recirculation device according to the present invention.

### DESCRIPTION OF THE PREFERRED EMBODIMENTS

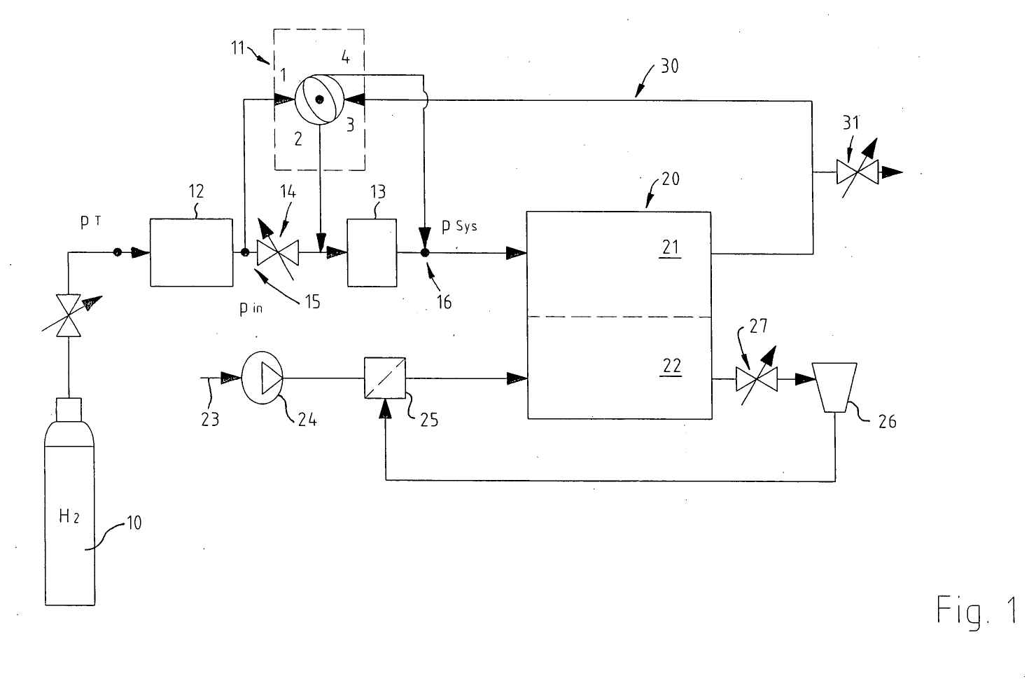

FIG. 1 is a schematic illustration of the basic design of a fuel cell system with a compressor 11 driven by the high pressure of the primary fuel and/or hydrogen 10. Primary hydrogen 10 flows through pressure-reduction valve 12 into compressor 11 with the aid of an opening. As viewed in the direction of flow, compressor 11 is located downstream from a pressure regulator 12, which reduces the pressure of hydrogen 10 from, e.g., 12 bar to, e.g., 9 to 10 bar (absolute). In the drive part of compressor 11—which can also be referred to as the HRB (hydrogen recirculation blower)—the original pressure at opening 1 is reduced to a pressure at opening 2 of, e.g., approximately 9 to 10 bar (absolute).

Partially depressurized hydrogen 10 flows out of compressor 11 to a hydrogen metering device 13 (HMD).

A bypass 14 is provided between pressure regulator 12 and hydrogen metering device 13, bypass 14 including a variable throttle 15 (e.g., a valve). As a result, hydrogen 10 can be supplied to a fuel cell 20 and/or a fuel cell stack 20 independently of compressor 11. As a result, the entire quantity of hydrogen capable of being supplied to an anode 21 of fuel cell 20 is decoupled from the recirculating operating material flowing out of anode 21 and/or fuel cell 20.

Fuel cell 20 also includes a cathode 22. Cathode 22 is preferably supplied with air. A fan 24 and a humidifier 25 prepare ambient intake air 23 accordingly.

In addition and as an option, a dehumidifer 26 can be provided at the outlet of cathode 22, which supplies water to humidifier 25. In addition, a control valve 27 can be provided at the outlet of cathode 22, so that, in particular, the pressure of fuel cell 20 can be advantageously adjusted.

According to the present invention, the operating material flowing out of fuel cell 20 is recirculated. Recirculation 13 preferably includes a valve 31 and/or a blow-off valve 31 for blowing off residual gasses that accumulate in anode 21. Valve 31 is closed during normal operation. It is advantageously opened and closed at a certain frequency to blow off residual gasses, e.g., nitrogen and water vapor, that accumulate in anode 21, to the surroundings and thereby prevent contamination of the anode gas and prevent reduction of the stack efficiency.

The operating material to be recirculated is directed toward an opening 3 of compressor 11, is compressed in compressor 11, and subsequently flows out of opening 4, so that the operating material can be combined with hydrogen 10 at one point 16 and flow toward anode 21.

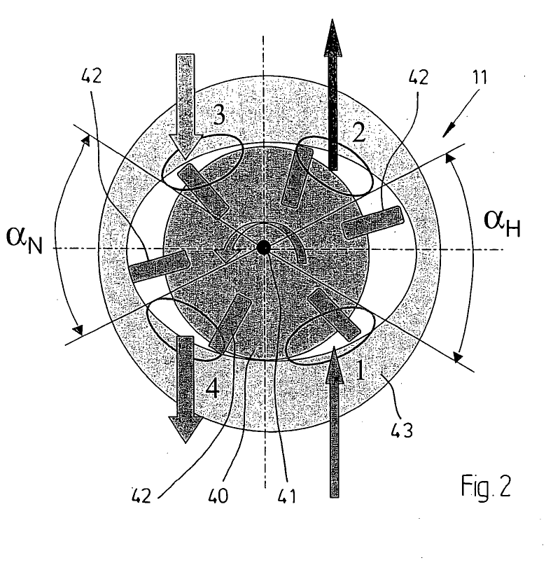

The method of operation of compressor 11 is illustrated in the detained illustration in FIG. 2. FIG. 2 shows that the process of expanding primary hydrogen 10 drives compressor 11. Compressor 11 draws in the operating material and excess hydrogen from the outlet of anode 21 and compresses it to the anode inlet pressure, which is approximately 0.3 to 0.5 bar above the anode outlet pressure. As described above, hydrogen 10 is directed back to the inlet of anode 21 (refer to FIG. 1).

All or part of primary hydrogen 10 can be redirected via bypass valve 15, depicted as variable throttle 15, on the drive side. When valve 15 is closed, the entire quantity of hydrogen flows through the drive part of compressor 11. When valve 15 is open, the hydrogen quantity flows directly to metering device 13. In this case, compressor 11 stops. The output of compressor 11 can be adapted to the requirements of the system on the recirculation via intermediate settings of variable throttle 15. Valve 15 is advantageously electrically controlled with the aid of a control unit.

Compressor 11 shown in FIG. 2 operates according to the vane pump principle. In the right chamber, primary hydrogen 10 is directed toward inlet opening 1. Supplied hydrogen 10 is depressurized and drives rotor 40 via the principle of expansion. The chamber shown on the left in FIG. 2 is the actual compressor. The excess hydrogen and/or hydrogenous flow of exhaust gas is drawn from the outlet of anode 21 into inlet opening 3 and is compressed according to the vane pump principle to the anode inlet pressure, approximately 0.3 to 0.5 bar higher than the anode outlet pressure. The compressed hydrogen is subsequently directed through outlet opening 4 toward the inlet side of anode 21. In the example, expanders and compressors are realized using the same rotor 40, which rotates around a common shaft 41.

In the example shown in FIG. 2, sliding vanes 42 move in the radial direction in rotor 40, so that they adapt to the inner wall surface of a stator 43 and/or a housing 43. Sliding vanes 42 can be pressed radially outwardly, e.g., with the aid of a not-shown spring and/or elastomer or the like, and/or they are automatically pressed outwardly during operation with the aid of centrifugal force, thereby sealing off the particular working areas.

Angles α_{H} and α_{N} between openings 1 and 2, and 3 and 4 must be greater than the angle between two adjacent sliding vanes 42, so that the expansion and compression processes in the two chambers function as smoothly as possible.

The mode of operation of a recirculation compressor driven by the primary hydrogen is not limited to the vane pump principle. Other expansion and flow principles and compression principles are also feasible, e.g., the roller cell, piston or membrane principle, and the side channel, axial, radial and suction jet pump principles.

It will be understood that each of the elements described above, or two or more together, may also find a useful application in other types of constructions differing from the types described above.

While the invention has been illustrated and described as embodied in a fuel cell system with a recirculating operating material, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A fuel cell system, comprising a fuel cell unit including an anode; a recirculation unit for recirculating hydrogenous operating material flowing out of said fuel cell unit back into said fuel cell unit, said recirculation unit having at least one drive unit for driving a flow of an operating material, said drive unit being configured as a drive unit selected from the group consisting of a pneumatic drive unit of a hydraulic drive unit for utilizing an energy of a fluid.

2. A fuel cell system as defined in claim 1, wherein said drive unit is configured as an expansion machine for utilizing an expansion energy the fluid which expands.

3. A fuel cell system as defined in claim 1, wherein said recirculating unit includes at least one compressor for compressing a substance selected from the group consisting of the operating material, the fluid, and both.

4. A fuel cell system as defined in claim 3; and further comprising a mechanical coupling device for coupling said compressor with said drive unit selected from the group consisting of said mechanic drive unit and said hydraulic drive unit.

5. A fuel cell system as defined in claim 4, wherein said coupling device includes at least one shaft.

6. A fuel cell system as defined in claim 3, wherein said drive unit selected from the group consisting of a pneumatic drive unit and a hydraulic drive unit, and said compressor have a common housing.

7. A fuel cell system as defined in claim 3, wherein said compressor has compressor elements configured as expansion elements of an expansion machine.

8. A fuel cell system as defined in claim 3, wherein said compressor has compressor elements configured as vanes of a rotor.

9. A fuel cell system as defined in claim 7, wherein said expansion elements are configured as vanes of a rotor.

10. A fuel cell system as defined in claim 1, wherein the fluid is substantially a fuel for said fuel cell unit.

11. A fuel cell system as defined in claim 1; and further comprising at least one bypass for bypassing said drive unit.

12. A fuel cell system as defined in claim 1; and further comprising a fuel pressure accumulator, said drive unit being located in a flow between said fuel pressure accumulator and said fuel cell unit.
